(19) United States
(12) Patent Application Publication
(10) Pub. No.: US 2016/0163105 A1
(43) Pub. Date: Jun. 9, 2016

(54) METHOD OF OPERATING A SURGICAL NAVIGATION SYSTEM AND A SYSTEM USING THE SAME

(71) Applicants: KOH YOUNG TECHNOLOGY INC., Seoul (KR); DAEGU GYEONGBUK INSTITUTE OF SCIENCE AND TECHNOLOGY, Daegu (KR)

(72) Inventors: Jaesung HONG, Daegu (KR); Hyun-Seok CHOI, Daegu (KR)

(21) Appl. No.: 14/441,398

(22) PCT Filed: Aug. 26, 2014
(86) PCT No.: PCT/KR2014/007909

§ 371 Date: May 7, 2015

(30) Foreign Application Priority Data
Aug. 26, 2013 (KR) 10-2013-0100945

(51) Int. Cl. G06T 19/00; G06T 7/00; G06T 3/00; G06T 1/00

(52) U.S. Cl. CPC G06T 19/003; G06T 1/0007; G06T 7/0081; G06T 3/0006; G06T 7/0051; G06T 19/006; G06T 2207/10028; G06T 2210/41; G06T 2200/08; G06T 2207/30004

(57) ABSTRACT

A method of operating a surgical navigation system is disclosed in which a user may easily recognize a depth perception between virtual organ models and a depth relationship between the virtual organ model and a surgical instrument by switching a two-dimensional organ image which is formed through an augmented reality to a virtual organ mode by three-dimensionally rendering the organ image. A method of operating a surgical navigation system comprises identifying an object from a body image captured by a camera, forming the object in a two-dimensional organ image by using an augmented reality, and forming a virtual organ model by three-dimensionally rendering the organ image.

### TECHNICAL FIELD

The present invention relates to a method of operating a surgical navigation system and a system using the same which provides a user to easily recognize a depth perception between each virtual organ model and a depth relationship between a virtual organ model and a surgical instrument in a virtual reality by rendering a two dimensional organ image, which is formed through an augmented reality, to a three dimensional virtual organ model.

### BACKGROUND ART

A surgical navigation system using an augmented reality is a system that expresses an anatomical structure on a real image of a patient, which is captured by a camera, by using a virtual object such as a skin, internal of an organ and so on which are not actually possible to photograph. And, it is possible to prevent a damage of an organ during a surgery and reduce unnecessary incision by using the system.

Meanwhile, a user (doctor) may feel difficulty on recognizing a depth perception during the use of a surgical navigation system using an augmented reality. There is concern over damaging unwanted region when a user (doctor) does not recognize accurately a depth perception between a surgical instrument and an organ of a patient on a visualized surgical navigation system. In an augmented reality, three-dimensional virtual objects are projected on a two-dimensional image, and therefore, it is difficult to recognize a depth relationship between an actual position of a patient and several virtual objects, especially, it is difficult to recognize a depth relationship between each virtual organ when virtual organs are projected semi transparently.

In order to solve those problems of a depth recognizing, it has been developed various method of visualizing. The most representative used method is giving a depth perception by adjusting contrast ratio between virtual organs. However, it becomes more difficult to give a depth perception since a contrast ratio of objects may not be expressed accurately when objects are semi transparent, or when a target range is wide.

Also, it is frequently used a visualizing method combined with stereovision and Head Mounted Display, but, such a method, like Head Mounted Display, may cause fatigue when a user wears the display for a long time.

Thus, a surgical navigation system which enables user to easily feel a depth perception without a fatigue is barely required.

### DETAILED DESCRIPTION OF THE INVENTION

### Objects of the Invention

Therefore, the present invention is to solve the above-described problem, the object of the present invention is to provide a method of operating a surgical navigation system and a system using the same which provides a user to easily recognize a depth perception between each virtual organ model by inputting a selection signal for a two-dimensional virtual image which is visualized through an augmented reality, three-dimensionally rendering and forming to a virtual organ model based on a point of the inputted selection signal within the organ image, and moving, directly by a user, a visualizing point of a virtual camera in a virtual reality.

Also, the object of the present invention is to provide a method of operating a surgical navigation system and a system using the same which provides a user to easily recognize a depth relationship between a virtual organ model and a surgical instrument in a virtual reality by expressing in real-time a position relation (direction and distance) between a virtual organ and a surgical instrument on a screen.

### Technical Solution

A method of operating a surgical navigation system to solve the above problems comprises identifying an object from a body image captured from a camera, visualizing a two-dimensional organ image of the object by using an augmented reality, and forming a virtual organ image by three-dimensionally rendering the organ image.

Also, a surgical navigation system to solve the above problems includes an object identifying part which identifies an object from a body image capture by a camera, an image forming part which forms a two-dimensional organ image of the object by using an augmented reality, and an organ model forming part which forms a virtual organ model by three-dimensionally rendering the organ image.

### Advantageous Effects

According to an embodiment of the present invention, a method of operating a surgical navigation system and a system using the same is provided in which a user easily recognizes a depth perception between each virtual organ model and directly moves a viewpoint of a virtual camera by three-dimensionally rendering the organ image based a point of the inputted selection signal within the two-dimensional organ image which is formed by an augmented reality, and forming to a virtual organ model the organ image.

Also, according to an embodiment of the present invention, a user may accurately recognize a virtual organ in a virtual reality by expressing in real-time a position relation (direction and distance) between a virtual organ model and a surgical instrument.

### DESCRIPTION OF THE DRAWINGS

FIG. 1 is a detailed diagram of a surgical navigation system according to an embodiment of the present invention;

FIGS. 2A and 2B are figures showing an example of a two-dimensional organ image and an example of a virtual organ model, respectively;

FIGS. 3A and 3B are figures showing an example of forming an augmented reality into a virtual reality according to an input of a selection signal;

FIG. 4 is a figure showing an example of expanding a virtual organ model in a virtual reality; and

FIG. 5 is a flow chart showing a method of operating a surgical navigation system according to an embodiment of the present.

### MODE FOR INVENTION

The present invention is described more fully hereinafter with reference to the accompanying drawings, in which example embodiments of the present invention are shown. The present invention may, however, be embodied in many different forms and should not be construed as limited to the example embodiments set forth herein. Like reference numerals in the drawings denote like elements.

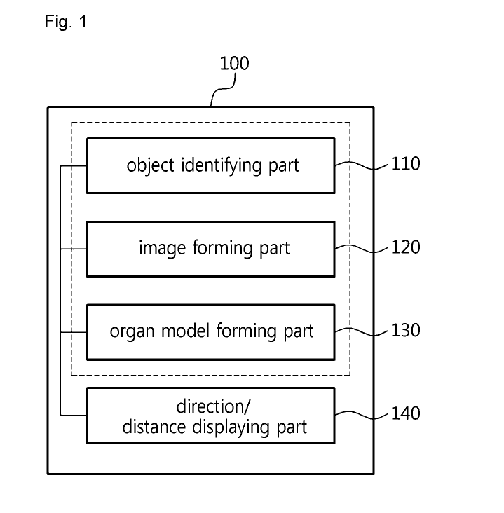

FIG. 1 is a detailed diagram of a surgical navigation system according to an embodiment of the present invention.

A surgical navigation system 100 according to an embodiment of the present invention may include an object identifying part 110, an image forming part 120 and an organ model forming part 130. Also, according to an embodiment, a surgical navigation system may further include a direction/distance displaying part 140.

The object identifying part 110 identifies an object from a body image which is captured by a camera.

Herein, an area in which an organ of a patient is positioned or supposed to be positioned within the body image such as a brain, a heart, or a stomach may be designated as the object. Also, a surgical navigation system 100 according to an embodiment of the present invention may maintain a general form of each organ such as a brain, a heart, or a stomach as a regular model.

In one embodiment, the object identifying part 110 projects the body image to a regular mode of an organ, and identifies an object within the body image which overlaps within the regular model in a predetermined range. For example, the object identifying part 110 may project the body image to each of a regular form of a brain, a regular form of a heart, a regular form of a stomach, and so on, which are maintained in the surgical navigation system, and identifies each object within the body image which overlaps within a 70%.

The image forming part 120 forms a two-dimensional image of the object by using an augmented reality.

A surgical navigation system 100 according to an embodiment of the present invention may maintain a DICOM (Digital Imaging and Communication in Medicine) image of a patient which is an body image captured by a camera. Herein, an image which is obtained by capturing a patient in different directions (for example, front, side, or cross section) by using CT, MRI, or X-Ray may be named as DICOM image.

In one embodiment, the image forming part 120 may two-dimensionally render the DICOM image of a regular model, which is associated to an identification, in a plane form. For example, when an object corresponding to a brain is identified within the body image, the image forming part 120 two-dimensionally renders each of multiple images of DICOM which are captured images of a patient's brain in different directions, and may form a two dimensional image of a brain in the identified area of the object in the body image.

The organ model forming part 130 may form a virtual organ model by three-dimensionally rendering the organ image.

In one embodiment, the organ model forming part 130 receives a selection signal, which includes a touch signal and a click signal, of the organ image, and may three-dimensionally render a point at which the selected signal is inputted.

In other words, the organ model forming part 130 may smoothly switch a screen from a two-dimensional augmented reality to a three-dimensional virtual reality without changing the screen (in other words, a position and a focus of a virtual camera is maintained according to the camera) according to the received selection signal of the organ image.

Herein, the organ model forming part 130 may express a depth perception of the organ model which is generated in the organ image having a plane form by using a perspective of a plane form. Also, the organ model forming part 130 may easily express a position relation and a depth perception between the organ models in a switched virtual reality display by performing at least one of rotating, scaling up and scaling down the organ model which is operated with a selection signal which includes a touch signal and a click signal.

Thus, according to an embodiment of the present invention, a surgical navigation system and a method of operating the same is provided in which a user may easily recognize a depth perception between virtual organs and directly moves a visual point of a virtual camera in a virtual reality by forming the organ image to a three-dimensional virtual image based on a point of a selection signal according to the inputted selection signal of a two-dimensional organ image formed through an augmented reality.

Also, according to an embodiment, a surgical navigation system 100 may further include a direction/distance displaying part 140 which provides a user a depth perception between virtual organ models in a virtual reality, as well as, a depth relation between a virtual organ model and a surgical instrument.

The direction/distance displaying part 140 may obtain a point positioned on a surface of the virtual model and relatively close to an end portion of a surgical instrument by using a nearest-neighbor search method, calculate a distance between the obtained point and the surgical instrument, and display the distance with the organ model in a screen. Also, the direction/distance displaying part 140 may calculate and display an entry direction of a surgical instrument that approaches to the organ model. Herein, the direction/distance displaying part 140 may display warning sign by stages according to the calculated distance.

Thus, according to an embodiment of the present invention, a position relation (direction and distance) between a virtual organ model and a surgical instrument is displayed in real-time, and therefore, a user may accurately recognize a depth relation between a virtual organ model in a virtual reality and a surgical instrument. In other words, an embodiment of the present invention provides a user with an intuitive depth perception by displaying the shortest distance between a virtual organ model and a surgical instrument in real-time, and therefore, a stability of a surgery is improved.

Meanwhile, a surgical navigation system 100 realizes an augmented reality by displaying each virtual camera corresponding to a camera and a patient, and a virtual patient or organ in a virtual reality, overlapping exactly a virtual organ and a real organ by projecting an image obtained by a camera on the rear of the virtual organ. And, in order to achieve this, a relationship between internal parameter value of a camera and positions of a camera and a patient may be identified.

In order to obtain the described internal parameter value of a camera, a Zhengyou Zhang's method of calibrating a camera may be used. The internal parameter value of the camera may be calculated by capturing images of a calibration device with chess shape for 50 times in different angles. Also, a position relation between a camera and a patient may be tracked in real-time by attaching passive markers on each patient and camera, and using an optical position tracker (Polaris Spectra, NDI, Waterloo, Canada, and so on).

A virtual space may be consisted by using an internal parameter value of a camera and a position relation between a patient and a camera. A field of view FOV of a virtual camera may be calculated by using a CCD's size and an internal parameter value of a real camera, and, a size of a screen to realize an augmented reality may be calculated by using parameter value of a camera and a relation between a camera and a patient.

In a virtual space, it is possible to observe an object (for example, an organ) by freely-moving a position of a virtual camera. A surgical navigation system 100 according to an embodiment of the present invention provides intuitive depth recognition by using advantages of an augmented reality and a virtual reality. For example, in order to naturally switch an augmented reality screen to a virtual reality screen without changing a position of an observing organ, a position of a virtual camera of a surgical navigation system 100 may be fixed, and a focus of a virtual camera may be headed for a virtual organ. Also, a surgical navigation system 100 visualizes a DICOM image on an augmented reality screen such that a depth is also recognized in an augmented reality, and helps a depth recognition by comparing a virtual object and a cross-sectional image of a patient.

Also, a surgical navigation system 100 solves the problem of recognizing a depth by tracking and visualizing in real-time a distance and a direction between an end portion of a surgical instrument and a surface of specific organ which is relatively close to the end portion of surgical instrument. In one embodiment, a surgical navigation system 100 registers surface data of a target organ by using KD Tree data structure to increase a tracking speed, obtains and visualizes in a screen a point positioned on a surface of a virtual object and relatively close to the end portion of surgical instrument by using nearest-neighbor search technique. Also, when a distance between the surgical instrument and surgical navigation system 100 becomes close, the surgical navigation system 100 displays warning by stages such that a user may recognize it.

Thus, according to an embodiment of the present invention, an augmented reality naturally is switched to a virtual reality without changing a screen, a user easily recognizes a depth between objects by directly moving a virtual camera in a virtual reality, an accurate depth relationship is visualized by displaying relationship between a virtual organ and a surgical instrument in real-time, and therefore, a surgical navigation system in which a user feels a depth without giving uncomfortable may be provided.

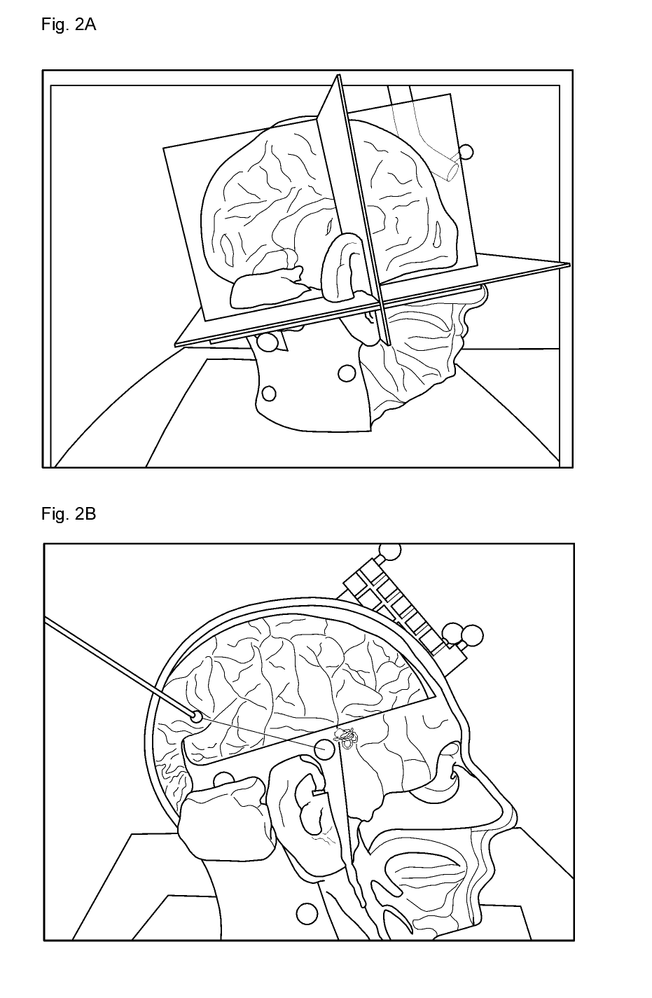

FIGS. 2A and 2B are figures showing an example of a two-dimensional organ image (FIG. 2A) and an example of a virtual organ model (FIG. 2B).

Referring to FIG. 2A, according to a surgical navigation system of an embodiment of the present invention, an organ image is visualized by two-dimensionally rendering a DICOM image of a regular model, which is related to the distinguishment of an object, in a plane form. In other words, a surgical navigation system captures images of a brain of a patient in multiple directions since an object corresponding to a “brain” is distinguished in a body image.

Plurality of DICOM images are two-dimensionally rendered, two-dimensional organ image related to a “brain” is visualized in an area of the distinguished object on the body image, and therefore, a depth perception is delivered by using the DICOM images.

When a selection signal such as a touch signal or a click signal is inputted in a screen in which the an organ image is displayed, a surgical navigation system switches the screen from a two-dimensional augmented reality to a three-dimensional virtual reality, renders the body image in three-dimensional with respect to a point at which the selection signal is inputted within the organ image, and therefore, a virtual organ such as FIG. 2B is visualized in a screen in a virtual reality. Herein, a surgical navigation system may deliver an accurate depth perception by tracking and visualizing a minimum distance and a direction between an end portion of a surgical instrument and a surface of specific organ which is relatively close to the end portion of surgical instrument.

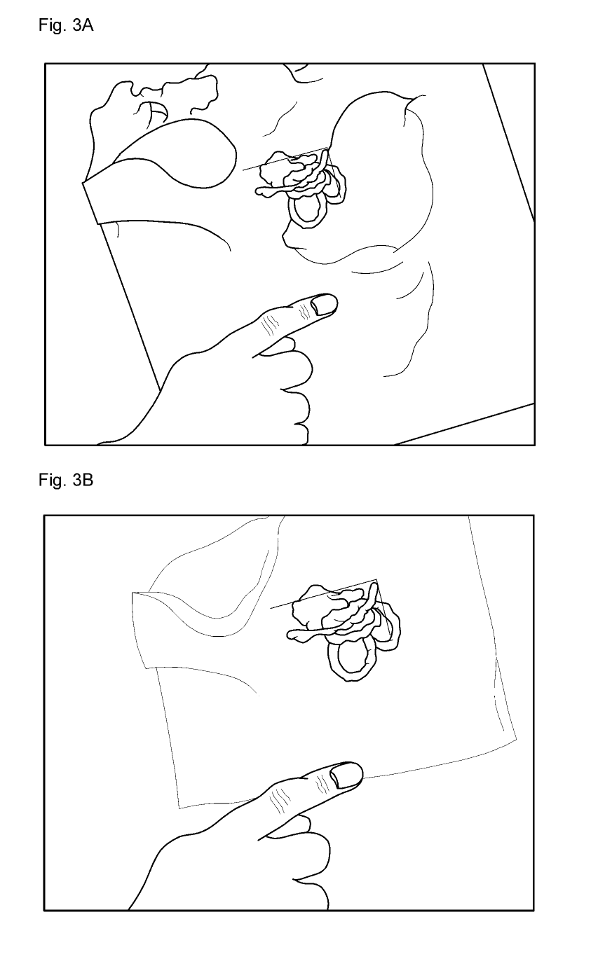

FIGS. 3A and 3B are figures showing an example of forming an augmented reality (FIG. 3A) into a virtual reality (FIG. 3B) according to an input of a signal.

Referring to FIGS. 3A and 3B, according to a surgical navigation system of an embodiment of the present invention, when a selection signal is inputted with respect to a two-dimensional body image which is visualized through an augmented reality of FIG. 3A, the two-dimensional augmented reality may be smoothly switched to a three-dimensional virtual reality without any change of a screen and maintaining a focus. In other words, as shown in FIG. 3B, a surgical navigation system according to an embodiment of the present invention three-dimensionally renders based on a point within the organ image, in which a selection signal is inputted, to change into a virtual organ model. Herein, a surgical navigation system expresses a depth perception of the virtual organ model by using perspective of a plane generated in the organ image having a planar form.

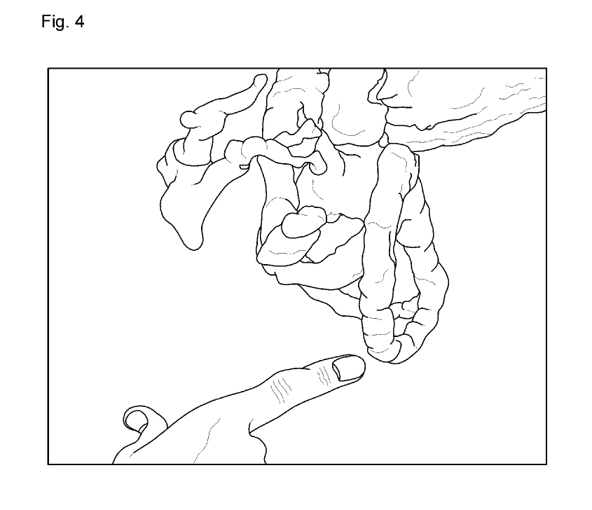

FIG. 4 is a figure showing an example of expanding a virtual organ model in a virtual reality.

Referring to FIG. 4, a surgical navigation system according to an embodiment of the present invention operates with a selection signal which includes a touch signal and a click signal with respect to a virtual organ shown in FIG. 3B, controls the organ model by performing at least one of rotating, scaling up, and scaling down, and easily expresses a position relation and a depth perception between the virtual organs. Also, a user may directly move viewpoint of a virtual camera in the virtual reality and easily recognize a depth perception between the virtual organs.

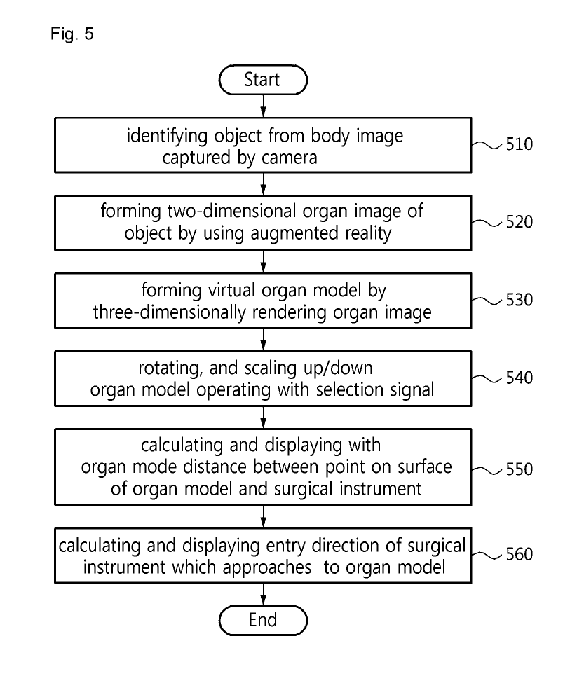

Hereinafter, a detailed workflow of operating a surgical navigation system 100 according to an embodiment of the present is shown in FIG. 5.

FIG. 5 is a flow chart showing a method of operating a surgical navigation system according to an embodiment of the present.

First, an object is identified by a surgical navigation system 100 from a body image captured by a camera (510).

For example, the surgical navigation system 100 identifies each object within the body image which is more than a range of 70% by projecting each of regular model for organ “brain”, regular model for organ “heart”, and regular model for organ “stomach” to the body image

Then, the object visualized in two-dimensional by the surgical navigation system 100 by using an augmented reality (520).

For example, when an object corresponding to an organ “brain” is distinguished in the body image, the surgical navigation system 100 two-dimensionally renders multiple DICOM images, which are captured images of a patient's brain in different direction, and may visualize the two-dimensional organ image which is an organ “brain” in the object area distinguished in the body image. Herein, the DICOM images may be images which are obtained by capturing images of a patient in various directions (for example, front section, side section, or cross section) using medical equipment such as CT, MRI, or X-ray, etc.

Then, by the surgical navigation system 100, a virtual organ model is formed by three-dimensionally rendering the organ image (530), the organ model is controlled by performing at least one of rotating, scaling up, and scaling down which is operated with a selection signal including a touch signal and a click signal with respect to the organ model (540).

The surgical navigation system 100 may smoothly switch from a two-dimensional augmented reality to a three-dimensional virtual reality without changing a screen (in other words, a position and a focus of a virtual camera corresponding to the camera is maintained) according to an inputted selection signal with respect to the organ image.

Herein, a surgical navigation system 100 expresses a depth perception of the virtual organ model by using perspective of a plane generated in the organ images having a plane form.

Finally, by the surgical navigation system 100, a distance between a point, which is positioned on a surface of organ model and relatively close at an end portion of a surgical instrument, and a surgical instrument is calculated and displayed in a screen with the organ model (550), and an entry direction of the surgical instrument that approaches to the organ model is calculated and displayed in the screen (560).

In detail, a surgical navigation system 100 obtains a point positioned on a surface of a virtual object and relatively close to the end portion of surgical instrument by using nearest-neighbor search technique, calculates a distance between the obtained point and the surgical instrument and an entry direction of the surgical instrument which approaches to the organ model, and displays the distance with the organ model in the screen. Herein, the surgical navigation system 100 displays warning by stages such that a user may recognize it.

Thus, according to an embodiment of the present invention, a position relation (direction and distance) between the virtual organ model and the surgical instrument is displayed in real-time, and therefore, a user may precisely recognize a depth relationship between the virtual organ and the surgical instrument in the virtual reality. In other words, the present invention provides to a user an intuitive depth perception and contributes to a reliability improvement of an operation by expressing a minimum distance between the virtual organ model and the surgical instrument.

A method according to an embodiment of the present invention described above, a variety of computer programs that can be performed by means of the command is implemented in the form of computer-readable media can be written to. The computer-readable medium and program instructions, data files, data structures, and include, alone or in combination may be Program that is written in the medium of instruction for example, or computer software specially designed and constructed things are known to those skilled in the art may be available. Examples of computer-readable media, hard disks, floppy disks, and magnetic media, such as magnetic tape (magnetic media), CD-ROM, DVD and optical recording media, such as (optical media), flop Political disk (floptical disk) and the self-optical media (magneto-optical media), and Rom (ROM), RAM (RAM), flash memory to store and perform program instructions, such as a specially configured hardware devices is included. Examples of program instructions, such as those produced by the compiler, interpreter, etc., as well as machine code using high-level language that can be executed by a computer contains code. Examples of hardware devices to perform the operation of one or more software modules can be configured to act as, and vice versa.

The detailed description of the present invention is described with regard to the preferable embodiment of the present invention, however, a person skilled in the art may amend or modify the present invention within the spirit or scope in the following claim of the present invention.

What is claimed is:

1. A method of operating a surgical navigation system comprising:
identifying an object from a body image captured by a camera;
forming the object in a two-dimensional organ image by using an augmented reality; and
forming a virtual organ model by three-dimensionally rendering the organ image.

2. The method of claim 1, wherein identifying an object comprises:
projecting the body image to a regular model for organ; and
identifying the object within the body image which overlaps the regular organ within a predetermined range.

3. The method of claim 1, wherein forming the object in a two-dimensional organ image comprises forming the organ image by two-dimensionally rendering a DICOM (Digital Imaging and Communication in Medicine) image of a regular model, which is related to the object identification, in a plane form.

4. The method of claim 3, wherein forming a virtual organ model comprises expressing a depth perception of the organ model by using a perspective of in a plane form which is generated in the organ image having a plane form.

5. The method of claim 1, wherein forming a virtual organ model comprises:
receiving a selection signal including a touch signal and a click signal with respect to the organ image; and
three-dimensionally rendering a point at which the selection signal is inputted.

6. The method of claim 1, further comprising controlling the organ model by performing at least one of rotating, scaling up and scaling down the organ model which is operated with a selection signal including a touch signal and a click signal with respect to the organ model.

7. The method of claim 1, further comprising:
obtaining a point positioned on a surface of the organ model and relatively close to an end portion of a surgical instrument by using a nearest-neighbor search technique; and
calculating a distance between the obtained point and the surgical instrument and displaying the distance with the organ model.

8. The method of claim 7, further comprising calculating and displaying an entry direction of the surgical instrument that approaches to the organ model.

9. The method of claim 7, further comprising displaying warning by stages according to the calculated distance.

10. A surgical navigation system comprising:
an object identifying part which identifies an object from a body image captured by a camera;
an image forming part which forms a two dimensional organ image of the object by using an augmented reality; and
an organ model forming part which forms a virtual organ model by three-dimensionally rendering the organ image.

11. The system of claim 10, wherein the organ model forming part controls the organ model by performing at least one of rotating, scaling up and scaling down of the organ model which is operated with an inputted selection signal including a touch signal and a click signal.

12. The system of claim 10, further comprising:
a direction/distance displaying part which obtains a point positioned on a surface of the organ model and relatively close to an end portion of a surgical instrument by using a nearest-neighbor search technique, calculates a distance between the obtained point and the surgical instrument, and displays the distance with the organ model in a screen.

13. The system of claim 12, wherein the direction/distance displaying part calculates and displays an entry direction of the surgical instrument that approaches to the organ model.
